(19) United States
(12) Patent Application Publication
(10) Pub. No.: US 2013/0197116 A1
(43) Pub. Date: Aug. 1, 2013

(54) Ultra High Strength Chalk Based Composition

(71) Applicant: Jack Elijah Williams, III, Houston, TX (US)

(72) Inventor: Jack Elijah Williams, III, Houston, TX (US)

(21) Appl. No.: 13/362,309

(22) Filed: Jan. 31, 2012

(51) Int. Cl. C08L 77/00; C08L 69/00; C08K 3/26; B82Y 30/00

(52) U.S. Cl. 521/138; 524/425; 521/134; 977/742

(57) ABSTRACT

Disclosed herein are ultra high strength compositions, such as comprising, in parts by weight: from about 20% to about 30% plastic; from about 55% to about 65% calcium carbonate; and from about 10% to about 20% fiber. Further disclosed is an ultra high strength composition, comprising, in parts by weight: from about 31% to about 39% plastic; from about 40% to about 50% calcium carbonate and from about 15% to about 25% fiber to which a foaming agent is added.

### BACKGROUND OF THE INVENTION

1. Field of the Invention

The present invention relates generally to the field of concrete like compositions. More specifically, the present invention relates to an ultra high strength chalk- or calcium carbonate-based composition.

2. Description of the Related Art

The American Society for Testing and Materials (ASTM) standard defines structural lightweight concrete as having a compression strength in excess of 17.2 MPa (2,500 psi) after 28 days curing when tested in accordance with ATSM C 330, and an air dry density not exceeding 1,842 kg/m3 (115 lb/ft3) as determined by ASTM C 567. Standard concrete mix is made of coarse aggregate (stone), fine aggregate (sand), and cement binder. Similarly to standard concrete mix, many current structural lightweight concrete mixtures have the same mix composition, except that the aggregates in the mix are replaced with lower-density ones. Lower-density replacement aggregates can be of man-made aggregates or natural aggregates, and have compression greater than structural strength of 2,500 psi. For example, most common man-made (synthetic) lightweight aggregates include expanded shale or clay, cinders, and expanded slag. The most common natural lightweight aggregates include pumice, scoria, tuff, and diatomite.

Currently, the use of structural lightweight concrete has been limited to large cast structures where its lower density is required, such as bridges and high rises. Like most normal concrete materials, its utilization in residential buildings has been limited due to its inflexibility, material cost, and associated labor cost in handling the material. The term “structural aggregate” is defined in the art as aggregate that has a compression strength that is greater that 2500 psi as consistent with the term “structural” referred in ASTM standard for concrete. The term “non-structural aggregate” is defined as aggregate with compression strength of 2500 psi or less.

In the second category of lightweight concrete, most are cellular concrete, perlite concrete, vermiculite concrete or the like. These types of lightweight concretes are often provided with non-structural strength and are limited in construction applications. Examples of such cellular concrete are disclosed in U.S. Pat. No. 4,900,359 entitled “Cellular concrete”; U.S. Pat. No. 5,183,505 entitled “Cellular concrete”; and U.S. Pat. No. 6,488,762 entitled “Composition of materials for use in cellular lightweight concrete and methods thereof”. Examples of such perlite concrete include U.S. Pat. No. 5,080,022 entitled “Composite material and method”, and U.S. Pat. No. 6,881,257 entitled “Machinable light weight sisal-based concrete structural building material”.

Cellular and non-structural aggregate, such as expanded vermiculite or perlite concrete, has been limited only to a few applications that do not require structural strength, but rather take advantage of the insulating characteristics. Past attempts to make this type of concrete into structural grade and make it more economical have resulted in failure. It is well known that a solid ordinary concrete made of fly ash, Portland cement and sand, can have a compression strength of 8,000-9,000 psi. This strength is much more than the structural requirement of most applications.

Thus, it would make sense to lighten it by introducing effective voids in the concrete. However, creating void cells in the concrete matrix has not been so easy for the last few decades. Moreover, obtaining desirable properties in cellular concrete or non-structural aggregate concrete with the least amount of material and labor cost can also be a science, given that exotic materials with limited supply required for any concrete mixes or certain complex manufacturing processes will always make the concrete expensive. Therefore, in order to be cost effective, the concrete has to be made using common materials that are abundant in supply; and its manufacture process must also be simple.

European patent application EP 0 934 915A1 describes a self-leveling, very high-performance concrete, containing in particular cement, a mixture of calcined bauxite sands of various particle sizes, silica fume, admixtures, such as a defoamer and a water-reducing super plasticizer, optionally fibers, and water. Such concretes have high mechanical properties, in particular a 28-day characteristic compressive strength of at least 150 MPa, a 28-day elastic modulus of at least 60 GPa and a 50-hour compressive strength of at least 100 MPa, these values being given for a concrete preserved and maintained at 20.degree. C.

Polycarbonates (PC) are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution. Polycarbonates are a useful class of polymers having many desired properties. They are highly regarded for optical clarity and enhanced impact strength and ductility at room temperature or below.

The prior art is deficient in a super strong chalk based compostion. The present invention meets this longstanding need and desire in the art.

### SUMMARY OF THE INVENTION

In one embodiment, the present invention is directed to an ultra high strength composition, comprising, in parts by weight: about 20% to about 30% plastic; about 55% to about 65% calcium carbonate particles; and about 10% to about 20% fiber. Representative examples of useful fibers include but are not limited to polyethylene, polypropylene, polyamide and polyvinyl alcohol homopolymer or copolymer fibers, aramid fibers, carbon fibers, carbon nanotube fibers and steel fibers. A representative example of a carbon fiber is HexTow® carbon fibers. A representative example of an aramid fiber is KEVLAR®. A representative example of a plastic is polycarbonate. A representative example of a polycarbonate is LEXAN®. Representative examples of calcium carbonate particles include but are not limited to ultrafine additions of calcium carbonate crystallized in the form of small cubes. Generally, the composition is moldable as an H beam, an I beam, or a joist and a truss. Generally, the ultra high strength composition has a compressive strength of at least 100 MPa.

In another embodiment, the present invention is directed to an ultra high strength composition, comprising, in parts by weight: about 31% to about 39% plastic; about 40% to about 50% calcium carbonate particles; and about 15% to about 25% fiber; and a foaming agent. Representative examples of useful fibers include but are not limited to polyethylene, polypropylene, polyamide and polyvinyl alcohol homopolymer or copolymer fibers, aramid fibers, carbon fibers, carbon nanotube fibers and steel fibers. A representative example of a carbon fiber is HexTow® carbon fibers. A representative example of an aramid fiber is KEVLAR®. A representative example of a plastic is polycarbonate. A representative example of a polycarbonate is LEXAN®. Representative examples of calcium carbonate particles include but are not limited to ultrafine additions of calcium carbonate crystallized in the form of small cubes. Representative examples of foaming agents includes polycarbonate resins. Generally, the composition is moldable as an H beam, an I beam, or a joist and truss. Generally, the ultra high strength composition has a compressive strength of at least 100 MPa.

Other and further aspects, features, and advantages of the present invention will be apparent from the following description of the presently preferred embodiments of the invention given for the purpose of disclosure.

### DETAILED DESCRIPTION OF THE INVENTION

As used herein, “a” or “an” in the specification may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the term “concrete” refers to a body of cementitious matrix which may, depending on the constructions to be formed, include fibers and is obtained by the hardening of a cementitious composition mixed with water. the term “ultra high-performance concrete” refers to a concrete having a characteristic 28-day compressive strength of 150 MPa or higher, this value being given for a concrete that has been preserved and maintained at 20° C. and has not undergone a cure or heat treatment.

Provided herein are ultra high strength composition or composite useful in all fields applicable to reinforced or nonreinforced concrete. To increase the properties of the concrete according to the invention, in certain constructions, fibers are incorporated into the concrete. These fibers may be synthetic, organic, mineral or metal fibers. In particular, they may be chosen from polyethylene, polypropylene, polyamide and polyvinyl alcohol homopolymer or copolymer fibers, carbon fibers, aramid fibers and steel fibers. These fibers may be of any shape and size. These fibers have a diameter of between 0.1 and 1.0 mm, preferably between 0.2 and 0.5 mm, and more preferably still around 0.3 mm, and a length of between 5 and 30 mm, preferably between 10 and 25 mm and even more preferably between 10 and 20 mm. Preferably, the fibers are “stronger than steel” fibers (STSF). In non-limiting examples, the carbon fibers are HexTow® carbon fibers and the aramid fibers are KEVLAR® fibers.

Moreover, a plastic and calcium carbonate particles may be added to the fibers to form an ultra high strength composition or composite. In non-limiting examples the plastic may be a polycarbonate, such as LEXAN®. As ultrafine calcium carbonate particles, one may use ultrafine calcium carbonate particles that are crystallized in the form of small cubes. Preferably, the ultra high strength composition or composite may comprise, by weight percent, about 20% to about 30% plastic, about 55% to about 65% calcium carbonate particles and about 10% to about 20% fiber.

Furthermore, a foaming agent may be added or incorporated into the ultra high strength composition or composite. Foaming agents are well-known and standard in the art of mixing concrete or concrete-like mixtures. One of ordinary skill in the art is well-able to select a foaming agent and determine the amount to add to the composition or composite mixture. For examples a foaming agent may be foamable polycarbonate resins. When a foaming agent is utilized the ultra high strength composition or composite comprises about 31% to about 39% plastic, about 40% to about 50% calcium carbonate particles and about 15% to about 25% fiber.

The present invention is explained in greater detail by means of the nonlimiting examples that follow. The amounts are in parts by weight, unless otherwise indicated.

In one example of the ultra-high strength composition or composite of the present invention, the composition comprises 25% plastic, 60% calcium carbonate and 15% fiber (10 mm to 20 mm). In a second example of the composition of the present invention, the composition comprises 35% plastic, 45% calcium carbonate, 20% fiber (10 mm to 20 mm) and a foaming agent added to the mixture of the ultra-high strength composition. Both examples utilize “stronger than steel fibers” (STSF) such as HexTow® carbon fibers or KEVLAR® aramid fibers. A representative example of a plastic is polycarbonate such as LEXAN®. A representative example of a foaming agent include foamable polycarbonate resins.

The above two compositions may be used in a variety of circumstances as would be readily recognized by a person having ordinary skill in this art. For example, the composition may be used in the creation of an H or an I beam, a Joist and a Truss. The stronger than steel fibers fabric and plastic composite can be made into a hollow H or I beam. To create a joist, the same composite shall be used to create pipes and connectors similar to pvc pipes and connectors for plumbing. The composite pipes and connectors can be cut and chemically connected to form a joist.

The composition described in example 1 can be injected into both the hollow beams and hollow joist until both are completely full. The composition described in Example 1 can be spayed on the exterior of hollow beams and/or hollow joists to protect the stronger than steel fabric. To create a truss, the composite plastic and stronger than steel fabric are placed into tubs the size of lumber (2×4, 2×6, 2×8, etc.) and connectors so that the tubs and connector can be assembled to form a truss. Alternatively, the composition described in Example 2 above can be injected into the truss until the truss is full. The foaming agent allows nails and screws to be attached and yields a lighter structure.

Both example 1 and example 2 compositions or composites can be used to create blocks similar to a concrete block. The composition described in example 1 can be used if maximal strength is desired and the composition described in example 2 can be used if a lighter but stronger than concrete composition is desired. The blocks can be stacked to form a wall but without mortar. Although fibers not exceeding a length of about 30 mm, such as the 10 mm to 20 mm fibers in the described in the composition of Example 1 are preferred, it is contemplated that fiber lengths may be increased to about 60 mm to about 80 mm. This composition or composite mixture can be sprayed on the surface of the wall inside and outside and holds better than a mortared wall. The compositions described in examples above can be pored, pumped, or injected into the wall to create a stronger or better-insulated wall. Moreover, one can drill into the composition, attach bolts thereto, and repair it easily in distinct contrast to a concrete block that will crack. Furthermore, any bolt holes left when a bolt is removed from the composition are easily repaired compared to a hole left in concrete.

For example, in earthquake zones, the composition described in example 2 can be used as mortar. A glue gun is used to melt the mixture and apply it to one brick at a time as needed. The composition described in example 2 can be sprayed to the back of new and old cement mortar walls to bind the bricks together.

Carbon fiber is 10 times stronger than steel and three times lighter than steel and carbon nano tubes are 100 times stronger than steel and 6 times lighter than steel. A person having ordinary skill in this art would readily recognize that one can use the composition described in Example 1 with carbon nanotube fibers in the example and carbon nanotube fiber cable where rebar goes in concrete. This greatly reduces the amount of concrete needed as well as the weight of a structure. Alternatively, one can mix more glass fiber with stronger than steel fibers and nylon plastic with a resulting product that is as strong as wood or, alternatively, one can add more stronger than steel fibers and have a stronger wood where needed. For example, this would be beneficial in hurricane zones. The connections on the truss, joist and/or wood joints can be plastic welded (dielectric sealing) and are stronger than steel.

The compression strength of polycarbonate is 80 MPa. In examples 1 and 2, 20% of the fiber by weight can be replaced with STSF pulp. The compression strength of the example 1 composition is at least 145 MPa. That of example 2 is at least 106 MPa. The compositions in examples 1 and 2 can be used in heavy timber construction. There will be a mold for each timber needed. Each mold is lined with STSF fabric, along with the joints, pin or bolt holds. The mold is injected with the composition of example 2 to form a solid timber. The timber is removed from the mold sanded and cleaned. The Example 1 composition, where all the fiber in it is replaced with STSF pulp, dyed or colored such that when sprayed on, as with an ink jet printer, the composition takes on the appearance of the color of the wood that is desired. Several coats may be needed to get the true look of wood.

One skilled in the art will readily appreciate that the present invention is well adapted to carry out the objects and obtain the ends and advantages mentioned, as well as those inherent therein. It will be apparent to those skilled in the art that various modifications and variations can be made in practicing the present invention without departing from the spirit or scope of the invention. Changes therein and other uses will occur to those skilled in the art which are encompassed within the spirit of the invention as defined by the scope of the claims.

What is claimed is:

1. An ultra high strength composition, comprising, in parts by weight:
about 20% to about 30% plastic;
about 55% to about 65% calcium carbonate particles; and
about 10% to about 20% fiber.

2. The composition of claim 1, wherein said fibers are selected from the group consisting of polyethylene, polypropylene, polyamide and polyvinyl alcohol homopolymer or copolymer fibers, aramid fibers, carbon fibers, carbon nanotube fibers, and steel fibers.

3. The composition of claim 2, wherein said carbon fiber is HexTow® carbon fibers.

4. The composition of claim 2, wherein said aramid fiber is KEVLAR®.

5. The composition of claim 1, wherein said plastic is polycarbonate.

6. The composition of claim 5, wherein said polycarbonate is LEXAN®.

7. The ultra high strength composition of claim 1, wherein said calcium carbonate particles are ultrafine additions of calcium carbonate crystallized in the form of small cubes.

8. The composition of claim 1, wherein said composition is moldable as an H beam, an I beam or a joist and truss.

9. The ultra high strength composition of claim 1, wherein said composition has a compressive strength of at least 100 MPa.

10. An ultra high strength composition, comprising, in parts by weight:
about 31% to about 39% plastic;
about 40% to about 50% calcium carbonate particles; and
about 15% to about 25% fiber; and
a foaming agent.

11. The composition of claim 10, wherein said fibers are selected from the group consisting of polyethylene, polypropylene, polyamide and polyvinyl alcohol homopolymer or copolymer fibers, aramid fibers, carbon fibers, carbon nanotube fibers and steel fibers.

12. The composition of claim 11, wherein said carbon fiber is HexTow® carbon fibers.

13. The composition of claim 11, wherein said aramid fiber is KEVLAR®.

14. The composition of claim 10, wherein said plastic is polycarbonate.

15. The composition of claim 14, wherein said polycarbonate is LEXAN®.

16. The ultra high strength composition of claim 10, wherein said calcium carbonate particles are ultrafine additions of calcium carbonate crystallized in the form of small cubes.

17. The composition of claim 10, wherein said foaming agent is a polycarbonate resin.

18. The composition of claim 10, wherein said composition is moldable as an H beam, an I beam or a joist and truss.

19. The ultra high strength composition of claim 10, wherein said composition has a compressive strength of at least 100 MPa.
